(19) United States
(12) Patent Application Publication
(10) Pub. No.: US 2024/0395437 A1
(43) Pub. Date: Nov. 28, 2024

(54) Glass Crack Repair Curing Lamp

(71) Applicant: Yiyan Guo, Ankang (CN)

(72) Inventor: Yiyan Guo, Ankang (CN)

(21) Appl. No.: 18/324,967

(22) Filed: May 27, 2023

(51) Int. Cl. G21K 5/02; G21K 5/08

(52) U.S. Cl. CPC G21K 5/02; G21K 5/08; C03C 27/10

(57) ABSTRACT

A glass crack repair curing lamp is disclosed, including a protective housing and an LED lamp panel. The LED lamp panel is installed in the protective housing, a button switch is mounted on a front surface of the protective housing, and suction cups are mounted on a rear surface of the protective housing away from the LED lamp panel. The present application belongs to the field of curing lamp technology, and more specifically relates to a glass crack repair curing lamp that can set a rated power and a rated working time, increase a set suction cups structure, and cooperate with an effective fixed distance for irradiation action to achieve fast and effective curing.

### TECHNICAL FIELD

The present application belongs to the field of curing lamp technology, and more specifically relates to a glass crack repair curing lamp.

### BACKGROUND

Existing technologies for glass crack repair are mainly repaired by resin bonding, but effects produced are minimal, because the resin used for automotive glass repair is usually UV shadowless glue, resin characteristics require a fixed power UV lamp for irradiation. However, the automotive glass repair kit on markets is not equipped with a unified curing repair lamp, which resulting in extremely poor repair results. Traditional handheld UV curing repair lamps are not convenient to use, fixation methods thereof are not uniform, and irradiation effects are greatly reduced, thus resulting in poor repair effects, difficult to operate and other difficulties. For this purpose, a glass crack repair curing lamp is proposed to solve above-mentioned technical problems.

### SUMMARY

In order to solve the above-mentioned problems, the present disclosure provides a glass crack repair curing lamp that can set a rated power and a rated working time, increase a set suction cups structure, and cooperate with an effective fixed distance for irradiation action to achieve fast and effective curing.

To achieve above functions, technical solutions of the present disclosure are as follows. A glass crack repair curing lamp is provided, including a protective housing and an LED lamp panel. The LED lamp panel is installed in the protective housing, a button switch is mounted on a front surface of the protective housing, and suction cups are mounted on a rear surface of the protective housing away from the LED lamp panel.

Preferably, a control circuit board is installed in the protective housing, the control circuit board is configured with two power ratings and two rated hours.

Preferably, the control circuit board is electrically connected to the button switch.

As a preferred embodiment of the present disclosure, the suction cups are set in two groups with a vertical centerline of the protective housing as an axis of symmetry.

As a preferred embodiment of the present disclosure, the protective housing is made of ABS materials.

The present disclosure has following advantages in adopting the above structures. The glass crack repair curing lamp provided by the present disclosure set two time nodes of different durations automatic switch and two different rated power irradiation mode, through two suction cups coordinate work, with adsorptive action in the bottom of the automotive glass, to achieve repair of “point-to-point, line-to-line” in the breakages, thus stable and fixed proximity irradiation effects are the best. The crack where applied the UV shadowless glue is performed a glass crack curing repair irradiation effect, to play a fixed role, meanwhile which can also be fixed power and fixed 2-4 minutes of repair time, thereby can achieve rapid repair, reduce the resin curing time, enhance the repair effect, and repair the type of glass cracks more comprehensive.

### BRIEF DESCRIPTION OF THE DRAWINGS

FIG. 1 illustrates a schematic diagram of an overall structure of a glass crack repair curing lamp in a front view direction in accordance with some embodiments of the present disclosure.

FIG. 2 illustrates a schematic diagram of an overall structure of a glass crack repair curing lamp in a rear view direction in accordance with some embodiments of the present disclosure.

In the drawings, the reference signs are as follows. 1. protective housing, 2. LED lamp panel, 3. button switch, 4. suction cup, 5. control circuit board.

### DETAILED DESCRIPTION OF THE EMBODIMENTS

The technical solutions of the present disclosure will be clearly and completely described below in connection with accompanying drawings, and it is clear that the described embodiments are a part of the embodiments of the present disclosure, and not all of them. Based on the embodiments in the present disclosure, all other embodiments obtained by a person of ordinary skill in the art without making creative labor fall within the scope of protection of the present disclosure.

In the description of the present disclosure, it should be noted that the terms “center”, “top”, “bottom”, “left”, “right”, “vertical”, “horizontal”, “inside”, “outside” etc. indicated orientation or positional relationship are based on an orientation or positional relationships shown in the accompanying drawings and are intended only to facilitate and simplify the description of the present disclosure, not to indicate or imply that the device or element referred to must have a particular orientation, be constructed and operate in a particular orientation, and therefore are not to be construed as limiting the present disclosure. Furthermore, the terms “first”, “second”, and “third” are used for descriptive purposes only and are not to be construed as indicating or implying relative importance. The present disclosure is described in further detail below in connection with the accompanying drawings.

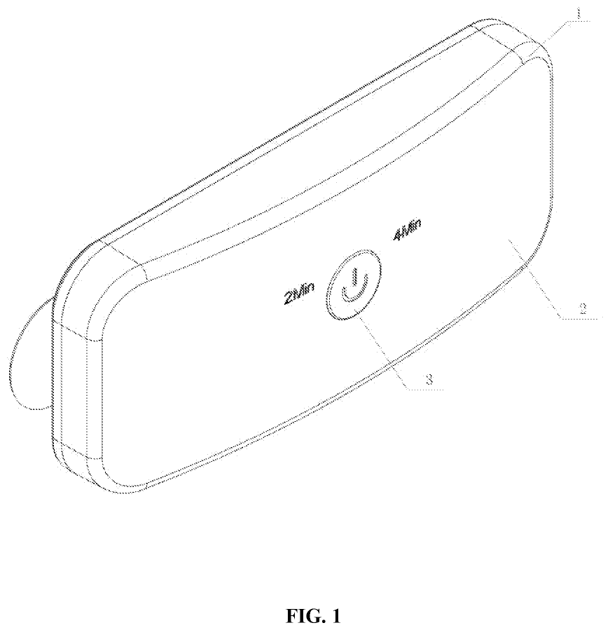

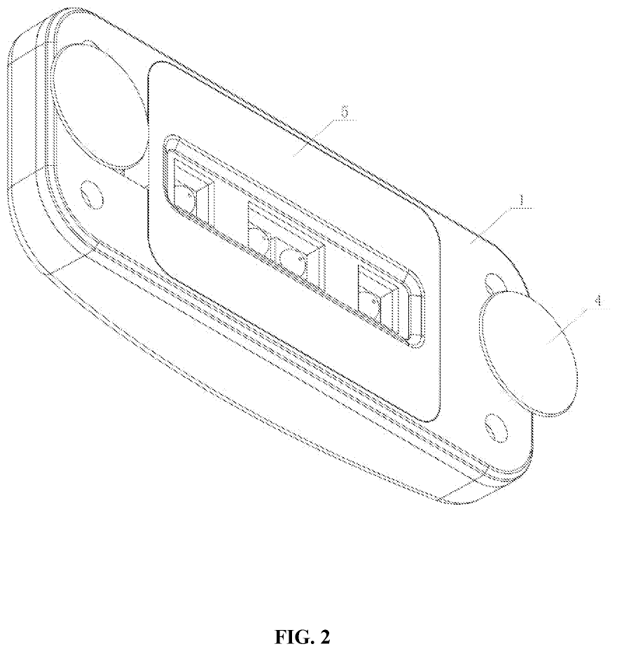

Referring to FIG. 1 and FIG. 2, the present disclosure provides a glass crack repair curing lamp, including protective housing 1 and an LED lamp panel 2. Herein the protective housing 1 is made of ABS materials, using semi-permeable characteristics of the materials to achieve effects of hidden instructions. The LED lamp panel 2 is installed in the protective housing 1, a button switch 3 is mounted on a front surface of the protective housing 1, and suction cups 4 are mounted on a rear surface of the protective housing 1 away from the LED lamp panel 2. The suction cups 4 are set in two groups with a vertical centerline of the protective housing as an axis of symmetry, and adsorbed on the bottom of the automotive glass to achieve repairs of “point-to-point, line-to-line” in the breakages, thus stable and fixed proximity irradiation effects are the best, without need of handheld irradiation.

A control circuit board 5 is installed in the protective housing 1, the control circuit board 5 is configured with two power ratings and two rated hours. The control circuit board 5 is electrically connected to the button switch 3, which controls the duration and irradiation power of turning on the LED lamp panel 2 for curing.

When specific use, use of two sets of suction cups 4 adsorbed in the bottom of the automotive glass, through the button switch 3 set the rated power irradiation mode and irradiation duration, the glass cracks where coated with UV shadowless glue are performed glass crack curing, irradiation and repair operations, thus can achieve rapid repair.

The above description of the present disclosure and its embodiments, such descriptions is not limiting, and what is shown in the accompanying drawings is only one of the embodiments of the present disclosure, and an actual structure is not limited to it. In a word if a person of ordinary skill in the art is inspired by it, without departing from the purpose of creation of the present disclosure, without creatively designing a structural mode and embodiment similar to the technical solutions, all shall fall within the scope of protection of the present disclosure.

I claim:

1. A glass crack repair curing lamp, comprising a protective housing (1) and an LED lamp panel (2); wherein
The LED lamp panel (2) is installed in the protective housing (1), a button switch (3) is mounted on a front surface of the protective housing (1), and suction cups (4) are mounted on a rear surface of the protective housing (1) away from the LED lamp panel (2).

2. The glass crack repair curing lamp according to claim 1, wherein a control circuit board (5) is installed in the protective housing (1), the control circuit board (5) is configured with two power ratings and two rated hours.

3. The glass crack repair curing lamp according to claim 2, wherein the control circuit board (5) is electrically connected to the button switch (3).

4. The glass crack repair curing lamp according to claim 3, wherein the suction cups (4) are set in two groups with a vertical centerline of the protective housing (1) as an axis of symmetry.

5. The glass crack repair curing lamp according to claim 4, wherein the protective housing (1) is made of ABS materials.
